(19) United States
(12) Patent Application Publication
(10) Pub. No.: US 2026/0269523 A1
(43) Pub. Date: Sep. 10, 2026

(54) CONNECTOR

(71) Applicant: SUMITOMO WIRING SYSTEMS, LTD., Mie (JP)

(72) Inventors: Kuniaki TANIDA, Mie (JP); Kazuo NAKAI, Mie (JP)

(21) Appl. No.: 19/556,308

(22) Filed: Mar. 4, 2026

(30) Foreign Application Priority Data
Mar. 5, 2025 (JP) 2025-034382

(51) Int. Cl. H01R 13/629

(52) U.S. Cl. CPC H01R 13/62938

(57) ABSTRACT

A connector includes a housing and a fixing member made of resin. The housing includes a main body and a flange protruding outward from the main body. The fixing member includes a fixing shaft, an operation lever, and a cam mechanism configured to move the fixing shaft in conjunction with operation of the operation lever. The fixing shaft includes a shaft portion and a protrusion protruding from the outer circumferential surface of the shaft portion and configured to sandwich a casing between the protrusion and the flange. The cam mechanism converts movement of the operation lever in an operating direction into movement of the fixing shaft in an axial direction. The fixing shaft moves between a locked position at which the casing is sandwiched between the flange and the protrusion and an unlocked position in conjunction with the movement of the operation lever in the operating direction.

### CROSS-REFERENCE TO RELATED APPLICATIONS

This application is based on and claims priority from Japanese Patent Application No. 2025-034382, filed on March 5, 2025, with the Japan Patent Office, the disclosure of which is incorporated herein in its entirety by reference.

### TECHNICAL FIELD

The present disclosure relates to a connector.

### BACKGROUND

A connector disclosed in JP 2010-211935 A includes a high-voltage electric wire bent into an L-shape, a terminal connected to a leading end of the high-voltage electric wire, a housing surrounding the leading end portion of the high-voltage electric wire and the terminal, and a shield shell covering the housing and fixed to the housing.

### SUMMARY

The connector disclosed in JP 2010-211935 A includes a flange that protrudes outward and has a through hole. The connector disclosed in JP 2010-211935 A is fixed to a casing by, for example, fastening a bolt inserted into the through hole of the flange to a screw hole provided in the casing. In the case of a structure that uses a bolt for fixing, metal constituting the bolt may corrode. If the bolt gets stuck due to the corrosion of metal, it becomes difficult to remove the connector from the casing.

An object of the present disclosure is to provide a connector that can suppress deterioration of handleability due to corrosion.

A connector according to the present disclosure includes a housing and a fixing member made of resin and configured to fix the housing to a plate-shaped casing, wherein the housing includes a main body and a flange protruding outward from the main body, the fixing member includes a fixing shaft, an operation lever for operating the fixing shaft, and a cam mechanism configured to move the fixing shaft in conjunction with operation of the operation lever, the fixing shaft includes a shaft portion inserted through a through hole provided in the flange and a protrusion protruding from an outer circumferential surface of the shaft portion and configured to sandwich the casing between the protrusion and the flange, the cam mechanism converts movement of the operation lever in an operating direction into movement of the fixing shaft in an axial direction, and in conjunction with the movement of the operation lever in the operating direction, the fixing shaft moves between a locked position at which the casing is sandwiched between the flange and the protrusion and an unlocked position at which a distance between the protrusion and the flange is longer than that at the locked position.

The connector according to the present disclosure can suppress deterioration of handleability due to metal corrosion.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector according to an embodiment.

FIG. 2 is an exploded perspective view of the connector according to the embodiment.

FIG. 3 is a side view showing a step of attaching the connector to a casing according to the embodiment.

FIG. 4 is a side view showing a state in which a fixing shaft is located at an unlocked position according to the embodiment.

FIG. 5 is a side view showing a state in which the fixing shaft is located at a top position according to the embodiment.

FIG. 6 is a side view showing a state in which the fixing shaft is located at a locked position according to the embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described.

1 A connector according to the present disclosure includes a housing and a fixing member made of resin and configured to fix the housing to a plate-shaped casing, wherein the housing includes a main body and a flange protruding outward from the main body, the fixing member includes a fixing shaft, an operation lever for operating the fixing shaft, and a cam mechanism configured to move the fixing shaft in conjunction with operation of the operation lever, the fixing shaft includes a shaft portion inserted through a through hole provided in the flange and a protrusion protruding from an outer circumferential surface of the shaft portion and configured to sandwich the casing between the protrusion and the flange, the cam mechanism converts movement of the operation lever in an operating direction into movement of the fixing shaft in an axial direction, and in conjunction with the movement of the operation lever in the operating direction, the fixing shaft moves between a locked position at which the casing is sandwiched between the flange and the protrusion and an unlocked position at which a distance between the protrusion and the flange is longer than that at the locked position.

According to this configuration, the fixing member used to fix the housing to the casing is made of resin. This prevents the occurrence of metal corrosion in the fixing member in the state where the connector is fixed to the casing, and prevents the fixing member from getting stuck due to the metal corrosion. Therefore, deterioration of handleability due to the metal corrosion can be suppressed.

2 In 1 described above, the cam mechanism may be an eccentric cam that converts movement of the operation lever in a rotational direction into movement of the fixing shaft in the axial direction, the fixing shaft may be coupled to the operation lever in such a manner as to be rotatable relative to the operation lever, and a second center that is a rotation center of the fixing shaft in the operation lever may be eccentric to a first center that is a rotation center of the operation lever.

With this configuration, by employing an eccentric cam having a simple structure, it is possible to suppress an increase in the number of components of members constituting the cam mechanism and complication of the shapes of the members constituting the cam mechanism.

3 In 2 described above, when a position of the fixing shaft when the second center is farthest from the flange is defined as a top position, the cam mechanism may be configured such that the fixing shaft moves from the locked position to the unlocked position via the top position in conjunction with the movement of the operation lever in the operating direction.

According to this configuration, when the operation lever is located at the top position, holding pressure applied by the protrusion of the fixing shaft to press the casing becomes the maximum, and a strong resisting force that pushes back the protrusion is generated as a reaction. Therefore, a force exceeding this resisting force is necessary to pass through the top position when the operation lever is moved from a position at which the fixing shaft is located at the locked position to a position at which the fixing shaft is located at the unlocked position. Accordingly, when the fixing shaft is located at the locked position, even if a force is applied by unintentional contact or the like to the operation lever in a direction to rotate the operation lever, it is possible to suppress rotation of the operation lever in such a direction that the fixing of the connector is canceled. As a result, the connector can be stably fixed to the casing.

4 In 2 or 3 described above, the connector may further include a resistance applying portion that applies resistance to movement of the operation lever in a direction from a rotational position of the operation lever when the fixing shaft is located at the locked position to a rotational position of the operation lever when the fixing shaft is located at the unlocked position.

According to this configuration, when the fixing shaft is located at the locked position, even if a force is applied to the operation lever by unintentional contact or the like in a direction to rotate the operation lever, it is possible to suppress rotation of the operation lever in the direction in which the fixing of the connector by the fixing shaft is canceled. As a result, the connector can be stably fixed to the casing.

5 In any one of 1 to 4 above, the fixing member may be an integral member obtained by attaching the fixing shaft to the operation lever, the through hole of the flange may have a non-circular cross-sectional shape, and rotation of the fixing shaft from a position where the protrusion cannot pass through the through hole to a position where the protrusion can pass through the through hole may be restricted due to the operation lever coming into contact with the main body. With this configuration, it is possible to prevent a situation in which the fixing shaft comes out of the through hole of the flange and the fixing member comes off the housing.

### Details of Embodiment of Present Disclosure

A specific example of a connector according to the present disclosure will be described below with reference to the drawings. In the drawings, a part of a configuration may be exaggerated or simplified for convenience of description. Also, dimensional proportions of respective portions may be different between the drawings. In this specification, "orthogonal" and "parallel" include not only strictly orthogonal and parallel cases, but also substantially orthogonal and parallel cases within a range where functions and effects of the present embodiment are achieved. The terms "first", "second", "third", and the like as used herein are used merely to distinguish objects from each other, and do not indicate an order of the objects.

In each of the drawings, an X-axis, a Y-axis, and a Z-axis that are orthogonal to each other are shown. The following describes, as an example, a case in which a connector 10 is oriented such that the Z-axis direction is an upward direction. The connector 10 is not limited to being used in this orientation, and may be used in an orientation in which the Z-axis direction is other than the upward direction, for example, a downward direction or a horizontal direction. Note that axial directions such as the Z-axis direction mean the directions in which the tips of the arrows of the corresponding axes are directed. The upward direction means a vertically upward direction, and the downward direction means a vertically downward direction.

### Configuration of Connector 10

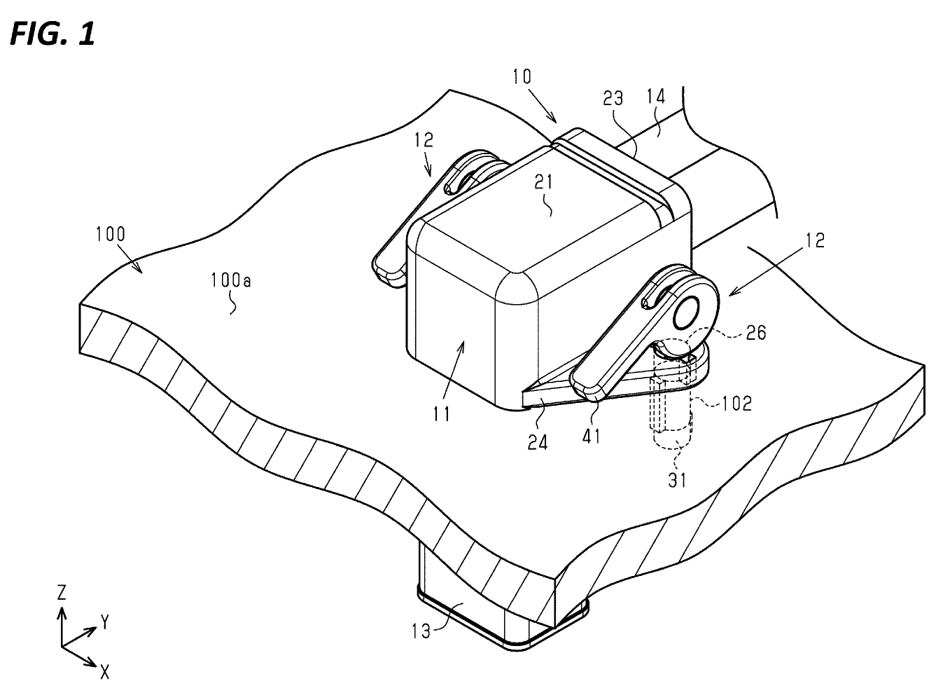

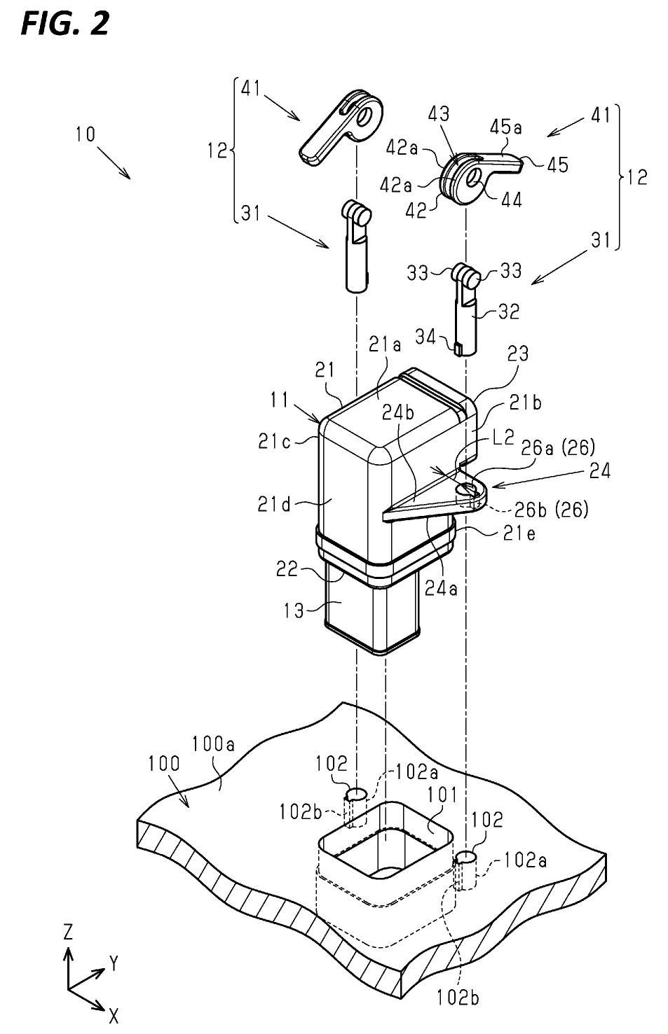

As shown in FIGS. 1 and 2, the connector 10 includes a housing 11 and fixing members 12 for fixing the housing 11 to a plate-shaped casing 100. The connector 10 further includes a fitting portion 13 accommodating terminals (not shown) therein, and a plurality of electric wires 14 accommodated in the housing 11. The fitting portion 13 is attached to a first opening 22 of the housing 11, which will be described later. First end portions of the electric wires 14, which are end portions on one side, are connected to the terminals, and second end portions opposite to the first end portions are drawn out to the outside through a second opening 23 of the housing 11, which will be described later. It should be noted that the electric wires 14 are omitted in FIG. 2 and the following drawings.

### Structure of Housing 11

As shown in FIG. 2, the housing 11 includes a main body 21 that accommodates the electric wires 14.

The main body 21 has a box shape and has an accommodation space for accommodating the electric wires 14. The shape of the main body 21 is not particularly limited, and can be set as appropriate according to the arrangement of the electric wires 14 and the like. The following describes, as an example, the main body 21 configured to accommodate the fitting portion 13 accommodating the terminals and the electric wires 14 bent into an L-shape.

The main body 21 has a rectangular box shape as a whole and has the first opening 22 that is open downward. The fitting portion 13 is attached to the first opening 22 of the main body 21. The main body 21 includes a rectangular upper wall 21a on the upper side, a first side wall 21b and a second side wall 21c next to each other in the X-axis direction with a distance therebetween, and a third side wall 21d and a fourth side wall 21e next to each other in the Y-axis direction with a distance therebetween. The second opening 23 is provided in an upper portion of the fourth side wall 21e to draw out the electric wires 14. The accommodating space in the main body 21 forms an L-shaped passage extending from the first opening 22 to the second opening 23.

The housing 11 includes two flanges 24 protruding outward from the main body 21. One of the two flanges 24 protrudes in the X-axis direction from a central portion in the Z-axis direction of the first side wall 21b, and the other flange 24 (not shown in the direction shown) protrudes in the direction opposite to the X-axis direction from a central portion in the Z-axis direction of the second side wall 21c. The two flanges 24 have the same configuration except that they are oriented in different directions. It should be noted that the housing 11 has a structure that is symmetrical with respect to the Y-Z plane in a central portion in the X-axis direction.

The flanges 24 have a plate-like shape and have a lower surface 24a on the lower side and an upper surface 24b opposite to the lower surface 24a. The flanges 24 have through holes 26 extending through the flanges in the Z-axis direction. The through holes 26 have a non-circular cross-sectional shape. In the example shown in the drawings, the cross-sectional shape of the through holes 26 is a keyhole shape including a circular main hole portion 26a and a rectangular extended portion 26b protruding from the main hole portion 26a. The cross-sectional shape of the through holes 26 is constant in the Z-axis direction.

### Configuration of Fixing Members 12

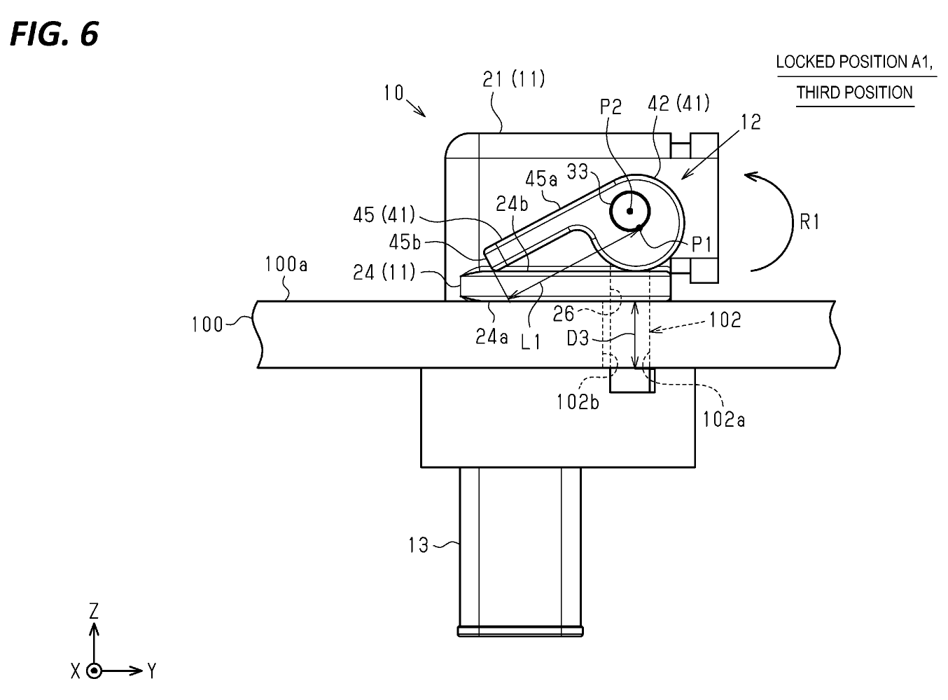

As shown in FIGS. 2 and 6, the fixing members 12 each include a columnar fixing shaft 31 extending in the Z-axis direction and an operation lever 41 for operating the fixing shaft 31. In order to facilitate understanding, FIG. 2 shows one of the fixing members 12 in an orientation opposite to the orientation shown in FIG. 1. Each fixing member 12 is configured as an integral member by assembling the fixing shaft 31 and the operation lever 41, which are formed as separate components. One fixing member 12 is attached to each of the two flanges 24 of the housing 11.

The fixing shaft 31 includes a columnar shaft portion 32 extending in the Z-axis direction. The cross-sectional shape of the shaft portion 32 allows the shaft portion to be inserted through the main hole portion 26a of the through hole 26 formed in each flange 24 and to rotate about an axis extending in the Z-axis direction in the main hole portion 26a. The cross-sectional shape of the shaft portion 32 is, for example, a circular shape that is slightly smaller than the main hole portion 26a.

An end portion of the shaft portion 32 in the Z-axis direction (hereinafter referred to as a base end of the fixing shaft 31) is provided with a pair of camshafts 33 that protrude from an outer circumferential surface of the shaft portion 32 in the X-axis direction and the direction opposite to the X-axis direction. Each of the pair of camshafts 33 has a cylindrical shape, and the centers of the camshafts 33 are on the same straight line. An end portion of the shaft portion 32 opposite to its base end (hereinafter referred to as a leading end of the fixing shaft 31) is provided with a protrusion 34 that protrudes from the outer circumferential surface of the shaft portion 32. The cross-sectional shape of the protrusion 34 orthogonal to the Z-axis direction allows the protrusion to pass through the extended portion 26b of the through hole 26 formed in each flange 24. The cross-sectional shape of the protrusion 34 is, for example, a rectangular shape that is slightly smaller than the extended portion 26b.

When the circumferential position of the protrusion 34 with respect to the shaft portion 32 coincides with the circumferential position of the extended portion 26b of the through hole 26, the leading end side portion of the fixing shaft 31 can pass through the through hole 26. When the circumferential position of the protrusion 34 with respect to the shaft portion 32 does not coincide with the circumferential position of the extended portion 26b of the through hole 26, the leading end side portion of the fixing shaft 31 comes into contact with the lower surface 24a of the flange 24 and therefore, cannot pass through the through hole 26.

The operation lever 41 includes a rotary portion 42 that is attached to the camshafts 33 of the fixing shaft 31. The rotary portion 42 includes an outer circumferential portion extending along a circumference having a first center P1 extending along the X-axis (see FIG. 6). More specifically, the rotary portion 42 includes a pair of disk-shaped side walls 42a arranged with a distance therebetween in the X-axis direction. Peripheral edges of the side walls 42a correspond to the arc-shaped outer circumferential portion of the rotary portion 42 described above, and have a shape extending along the circumference having the first center P1 extending along the X-axis.

The rotary portion 42 has an opening 43 through which the base end portion of the fixing shaft 31 is inserted to be disposed between the pair of side walls 42a. The opening 43 is formed like a slit or a groove, for example.

The two side walls 42a of the rotary portion 42 have bearing holes 44 into which the camshafts 33 provided at the base end of the fixing shaft 31 are inserted. Inner circumferential surfaces of the bearing holes 44 extend along a circumference having a second center P2 (see FIG. 6). The camshafts 33 disposed in the bearing holes 44 are slidable along the inner circumferential surfaces of the bearing holes 44. Accordingly, the camshafts 33 can rotate relative to the operation lever 41 about the second center P2. As shown in FIG. 6, the second center P2 is set at a position that is eccentric to the first center P1 of the rotary portion 42. In other words, the bearing holes 44 are arranged such that the second center P2, which is the rotation center of the camshafts 33, is positioned eccentrically with respect to the first center P1 of the rotary portion 42.

The operation lever 41 includes an operating portion 45 protruding radially outward from the rotary portion 42. The operating portion 45 is a handle gripped by a mounting operator when operating the operation lever 41. The operating portion 45 connects the pair of side walls 42a of the rotary portion 42 to each other, has a plate shape, and protrudes from an outer circumferential surface of the rotary portion 42 in the direction of a tangent thereof. The operating portion 45 has a first surface 45a continuous with the outer circumferential surface of the rotary portion 42.

In the operation lever 41, a distance L1 from the first center P1 of the rotary portion 42 to a leading end 45b of the operating portion 45 is longer than a distance L2 from the through hole 26 to the main body 21 of the housing 11 (see FIG. 2). Therefore, when the fixing shaft 31 inserted through the through hole 26 is rotated about the axis of the shaft portion 32, a part of the operation lever 41 abuts against the main body 21 of the housing 11 at a predetermined rotational position. Thus, the range in which the operation lever 41 is rotatable relative to the housing 11 is limited to a specific angular range.

Here, the circumferential position of the extended portion 26b in the through hole 26 of each flange 24 and the circumferential position of the protrusion 34 with respect to the shaft portion 32 of the fixing shaft 31 are set based on the above-described angular range. That is to say, the circumferential position of the protrusion 34 and the circumferential position of the extended portion 26b are set so as not to coincide with each other when the operation lever 41 is within the range in which the operation lever 41 is rotatable relative to the housing 11. In this case, rotation of the fixing shaft 31 from a position where the protrusion 34 cannot pass through the through hole 26 to a position where the protrusion 34 can pass through the through hole 26 is restricted due to the operation lever 41 coming into contact with the main body 21. With this configuration, it is possible to prevent a situation in which the fixing shaft 31 comes out of the through hole 26 and the fixing member 12 comes off the housing 11. It should be noted that the fixing shaft 31 is inserted through the through hole 26 of each flange 24 before the operation lever 41 is attached to the fixing shaft 31. Thereafter, the operation lever 41 is attached to the fixing shaft 31 inserted through the through hole 26.

The operation lever 41 includes a cam mechanism for converting movement of the operation lever 41 in an operating direction into movement of the fixing shaft 31 in an axial direction. The cam mechanism is an eccentric cam that converts movement of the operation lever 41 in a rotational direction into movement of the fixing shaft 31 in the axial direction. In this embodiment, the eccentric cam is formed by the shapes and arrangement of the rotary portion 42 of the operation lever 41 and the operation lever 41 and by the structure in which the operation lever 41 is coupled to the fixing shaft 31 so as to be rotatable relative to the fixing shaft 31.

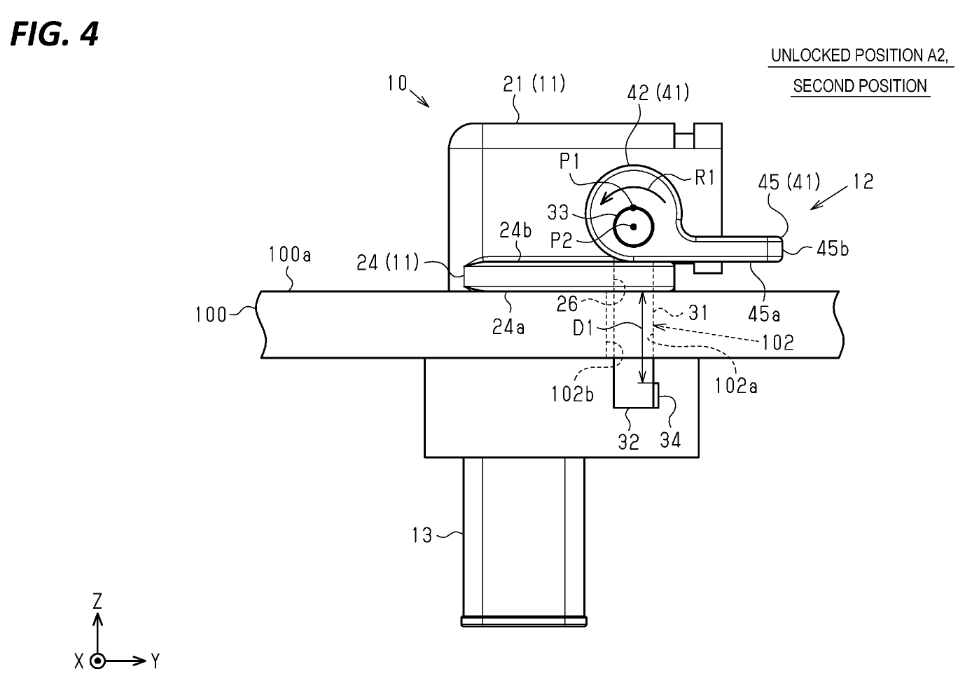

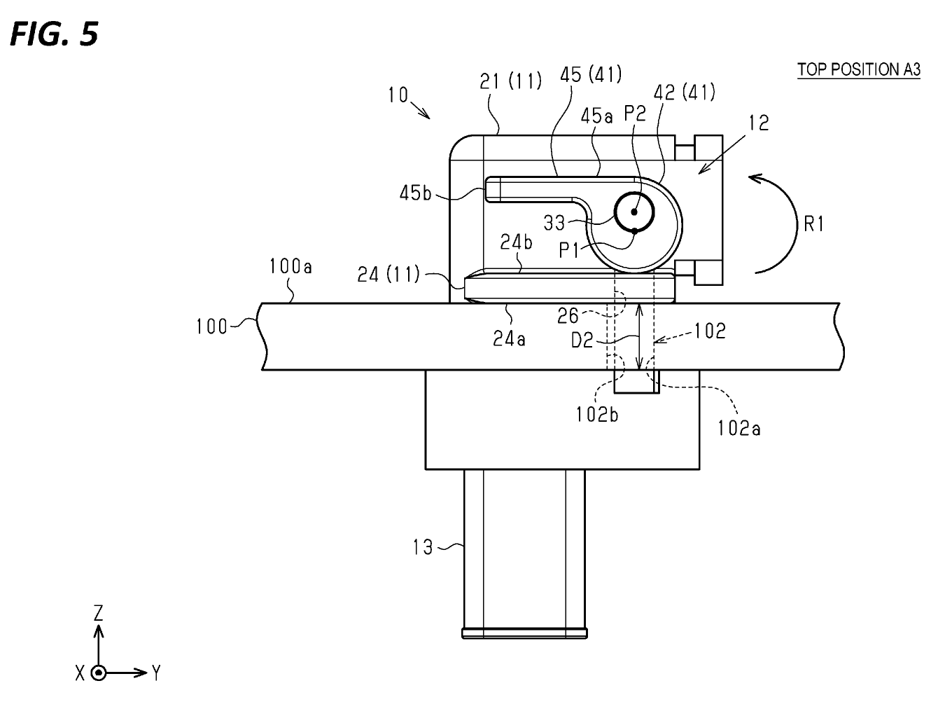

The cam mechanism is formed such that the fixing shaft 31 moves between a locked position A1 shown in FIG. 6 and an unlocked position A2 shown in FIG. 4 in conjunction with the movement of the operation lever 41 in the operating direction. Also, the cam mechanism is formed such that the fixing shaft 31 moves from the locked position A1 to the unlocked position A2 via a top position A3 shown in FIG. 5.

As shown in FIG. 4, the unlocked position A2 is set such that the distance in the Z-axis direction from the lower surface 24a of each flange 24 to the protrusion 34 of the corresponding fixing shaft 31 is larger than the thickness of the casing 100. One example of the unlocked position A2 is a position at which the distance from the lower surface 24a of the flange 24 to the protrusion 34 of the fixing shaft 31 is the maximum. Hereinafter, this distance when the fixing shaft 31 is located at the unlocked position A2 will be referred to as a "distance D1". When the fixing shaft 31 is at the unlocked position A2, the second center P2 of the camshafts 33 is between the first center P1 and the flange 24. In other words, the second center P2 of the camshafts 33 is closer to the flange 24 than the first center P1 is.

When the fixing shaft 31 is at the unlocked position A2, a part of the operating portion 45 is in contact with the upper surface 24b of the flange 24. For example, a part of the first surface 45a of the operating portion 45 is in contact with the upper surface 24b of the flange 24. At this time, the first surface 45a of the operating portion 45 is, for example, parallel to the upper surface 24b of the flange 24.

As shown in FIG. 5, the top position A3 is set as a position at which the second center P2 is farthest from the flange 24 in the Z-axis direction. The top position A3 can also be said to be a position at which the distance in the Z-axis direction from the lower surface 24a of the flange 24 to the protrusion 34 of the fixing shaft 31 is shortest. Hereinafter, this distance from the lower surface 24a of the flange 24 to the protrusion 34 of the fixing shaft 31 when the fixing shaft 31 is located at the top position A3 will be referred to as a "distance D2". The distance D2 is equal to the thickness of the casing 100 or slightly smaller than the thickness of the casing 100.

When the fixing shaft 31 is at the top position A3, the operating portion 45 of the operation lever 41 is spaced apart from the upper surface 24b of the flange 24. At this time, the first surface 45a of the operating portion 45 is, for example, parallel to the upper surface 24b of the flange 24. An example of the top position A3 is the position of the fixing shaft when the operation lever 41 is rotated 30 degrees from the locked position A1 in the direction opposite to a direction R1 about the first center P1.

As shown in FIG. 6, the locked position A1 is set such that the distance in the Z-axis direction from the lower surface 24a of the flange 24 to the protrusion 34 of the fixing shaft 31 is shorter than that when the fixing shaft is located at the unlocked position. Hereinafter, this distance from the lower surface 24a of the flange 24 to the protrusion 34 of the fixing shaft 31 when the fixing shaft 31 is located at the locked position A1 will be referred to as a "distance D3". The unlocked position A2 is set such that the distance in the Z-axis direction from the lower surface 24a of the flange 24 to the protrusion 34 of the fixing shaft 31 is longer than that when the fixing shaft is located at the locked position. Accordingly, the distance D3 when the fixing shaft 31 is located at the locked position A1 is shorter than the distance D1 when the fixing shaft 31 is located at the unlocked position A2.

Also, the distance D3 when the fixing shaft 31 is located at the locked position A1 is slightly longer than the distance D2 when the fixing shaft 31 is located at the top position A3. The distance D3 when the fixing shaft 31 is located at the locked position A1 is equal to the thickness of the casing 100, or slightly smaller or slightly larger than the thickness of the casing 100.

When the fixing shaft 31 is at the locked position A1, a part of the operating portion 45 is in contact with the upper surface 24b of the flange 24. For example, the leading end 45b of the operating portion 45 is in contact with the upper surface 24b of the flange 24. An example of the locked position A1 is the position of the fixing shaft when the operation lever 41 is rotated 210 degrees from the unlocked position A2 in the direction R1 about the first center P1. An example of the unlocked position A2 is the position of the fixing shaft when the operation lever 41 is rotated 180 degrees from the top position A3 in the direction opposite to the direction R1 about the first center P1.

The fixing members 12 are made of resin. That is to say, each fixing shaft 31 and each operation lever 41 are made of resin. The resin forming the fixing shaft 31 and the resin forming the operation lever 41 may be the same as each other or different from each other. Examples of the resin forming the fixing members 12 include at least one of polyacetal resin, polybutylene terephthalate, and polyamide resin.

### Functions of Present Embodiment

The following describes functions of the present embodiment.

As shown in FIG. 2, the casing 100 to which the connector 10 is to be attached includes one connector hole 101 and two fixing through holes 102. The connector hole 101 is a through hole into which a part of the main body 21 of the connector 10 and the fitting portion 13 are inserted. The fixing through holes 102 are through holes through which the fixing shafts 31 of the fixing members 12 are inserted. The fixing through holes 102 have the same cross-sectional shape as the cross-sectional shape of the through holes 26 of the flanges 24.

The cross-sectional shape of the fixing through holes 102 includes a circular main hole portion 102a and a rectangular extended portion 102b protruding from the main hole portion 102a. The circumferential position of the extended portion 102b in each fixing through hole 102 is set so as to coincide with the circumferential position of the protrusion 34 when the operation lever 41 is within the range in which the operation lever 41 is rotatable relative to the housing 11. Moreover, the circumferential position of the extended portion 102b in each fixing through hole 102 is set so as not to coincide with the circumferential position of the protrusion 34 with respect to the shaft portion 32 when the operation lever 41 is at the unlocked position A2.

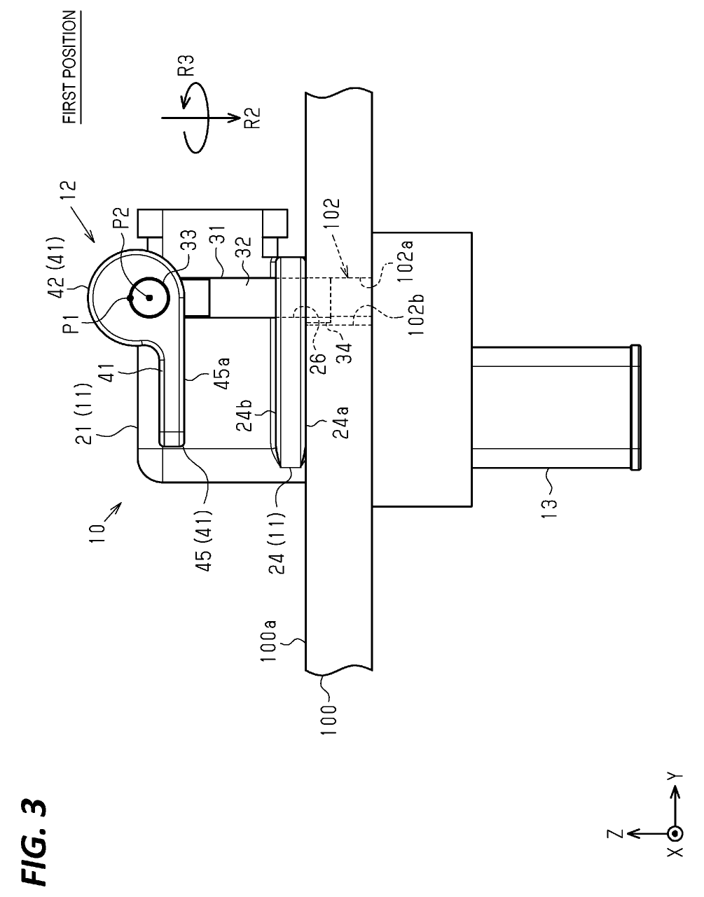

As shown in FIG. 3, when the connector 10 is to be attached to the casing 100, first, the operation lever 41 is moved to a first position. The first position is, for example, a position at which the first surface 45a of the operating portion 45 faces the flange 24 side and the leading end of the operating portion 45 is directed opposite to the Y-axis direction. Then, the main body 21 of the connector 10 is inserted into the connector hole 101 of the casing 100 from a mounting surface 100a side of the casing 100, and the connector 10 is placed on the mounting surface 100a such that the lower surface 24a of each flange 24 comes into contact with the mounting surface 100a of the casing 100. Then, the leading end portion of the shaft portion 32 including the protrusion 34 is passed through the corresponding fixing through hole 102 as indicated by an arrow R2 so that the entire protrusion 34 of the shaft portion 32 is located under the casing 100. Thus, the fixing shaft 31 is located at the unlocked position A2. It should be noted that, when the operation lever 41 is at the first position, the circumferential position of the extended portion 102b of each fixing through hole 102 coincides with the circumferential position of the corresponding protrusion 34 with respect to the shaft portion 32.

Next, the operation lever 41 is moved from the first position to a second position by being rotated a predetermined angle (for example, 180 degrees) about the axis of the fixing shaft 31 as indicated by an arrow R3. As shown in FIG. 4, the second position is, for example, a position at which the first surface 45a of the operating portion 45 faces the flange 24 side and the leading end of the operating portion 45 is directed to the Y-axis direction. In this state, the circumferential position of the extended portion 102b of each fixing through hole 102 does not coincide with the circumferential position of the corresponding protrusion 34 with respect to the shaft portion 32, which means that, when the fixing shaft 31 is moved in the axial direction, the protrusion 34 comes into contact with the casing 100 and keeps the fixing shaft 31 from coming out.

Next, the position of the operation lever 41 is moved from the second position to a third position shown in FIG. 6 by being rotated a predetermined angle (for example, 200 degrees) about the first center P1. When the operation lever 41 moves from the second position to the third position, the arc-shaped outer circumferential portion of the rotary portion 42 of the operation lever 41 slides on the upper surface 24b of the flange 24.

In conjunction with the rotation of the operation lever 41 operated as described above, the fixing shaft 31 moves in the axial direction. More specifically, in conjunction with the rotation of the operation lever 41, the fixing shaft 31 moves upward from the unlocked position A2 to the top position A3 shown in FIG. 5, and then moves downward from the top position A3 to the locked position A1 shown in FIG. 6.

As the fixing shaft 31 moves from the unlocked position A2 to the locked position A1, the protrusion 34 approaches the flange 24 as shown in FIG. 6. When the fixing shaft 31 is located at the locked position A1, the casing 100 is sandwiched between the protrusion 34 of the fixing shaft 31 and the flange 24, and thus the connector 10 is fixed to the casing 100.

Here, the holding pressure applied from the protrusion 34 and the flange 24 to the casing 100 becomes the maximum when the fixing shaft 31 is located at the top position A3 shown in FIG. 5. Although the holding pressure becomes slightly weak when the fixing shaft 31 reaches the locked position A1 past the top position A3, sufficient holding pressure is obtained even when the fixing shaft 31 is located at the locked position A1.

When the connector 10 is to be removed from the casing 100, a procedure reverse to the above operation is carried out. That is to say, the operation lever 41 is moved from the third position to the second position by being rotated about the first center P1 in the direction opposite to the direction in which the operation lever 41 is rotated about the first center P1 during the attachment of the connector 10. Thereafter, the operation lever 41 is moved from the second position to the first position by being rotated about the axis of the fixing shaft 31 in the direction opposite to the direction in which the operation lever 41 is rotated about the axis during the attachment of the connector 10. This allows the connector 10 to be removed from the casing 100.

### Effects of Present Embodiment

The following describes effects of the present embodiment.

1 The connector 10 includes the housing 11 and the fixing members 12 made of resin and configured to fix the housing 11 to the plate-shaped casing 100. The housing 11 includes the main body 21 and the flanges 24 protruding outward from the main body 21. The fixing members 12 each include the fixing shaft 31, the operation lever 41 for operating the fixing shaft 31, and the cam mechanism for moving the fixing shaft 31 in conjunction with operation of the operation lever 41. The fixing shaft 31 includes the shaft portion 32 that is inserted through the through hole 26 provided in each flange 24, and the protrusion 34 protruding from the outer circumferential surface of the shaft portion 32 and configured to sandwich the casing 100 between the protrusion 34 and the flange 24. The cam mechanism converts movement of the operation lever 41 in the operating direction into movement of the fixing shaft 31 in the axial direction. In conjunction with the movement of the operation lever 41 in the operating direction, the fixing shaft 31 moves between the locked position A1 at which the casing 100 is sandwiched between the flange 24 and the protrusion 34 and the unlocked position A2 at which the distance between the protrusion 34 and the flange 24 is longer than that at the locked position A1.

According to this configuration, the fixing members 12 used to fix the housing 11 to the casing 100 are made of resin. This prevents the occurrence of metal corrosion in the fixing members 12 in the state where the connector 10 is fixed to the casing 100, and prevents the fixing members 12 from getting stuck due to the metal corrosion. Therefore, deterioration of handleability due to the metal corrosion can be suppressed. In addition, the connector 10 can be fixed to the casing 100 by moving the operation lever 41 in the predetermined operating direction, which is a simple operation that an attachment operator can perform with his own hands. This eliminates the need for a special tool for fixing, such as an impact driver used to fasten bolts.

2 The cam mechanism is an eccentric cam that converts the movement of the operation lever 41 in the rotational direction into the movement of the fixing shaft 31 in the axial direction. The fixing shaft 31 is coupled to the operation lever 41 in such a manner as to be rotatable relative to the operation lever 41, and the second center P2, which is the rotation center of the fixing shaft 31 in the operation lever 41, is eccentric to the first center P1, which is the rotation center of the operation lever 41. With this configuration, by employing an eccentric cam having a simple structure, it is possible to suppress an increase in the number of components of members constituting the cam mechanism and complication of the shapes of the members constituting the cam mechanism.

3 The position of the fixing shaft 31 when the second center P2 is farthest from the flange 24 is defined as the top position A3. The cam mechanism is configured such that the fixing shaft 31 moves from the locked position A1 to the unlocked position A2 via the top position A3 in conjunction with the movement of the operation lever 41 in the operating direction.

According to this configuration, when the operation lever 41 is located at the top position A3, holding pressure applied by the protrusion 34 of the fixing shaft 31 to press the casing 100 becomes the maximum, and a strong resisting force that pushes back the protrusion 34 is generated as a reaction. Therefore, a force exceeding this resisting force is necessary to pass through the top position A3 when the operation lever 41 is moved from the position at which the fixing shaft 31 is located at the locked position A1 to the position at which the fixing shaft 31 is located at the unlocked position A2. Accordingly, when the fixing shaft 31 is located at the locked position A1, even if a force is applied by unintentional contact or the like to the operation lever 41 in a direction to rotate the operation lever 41, it is possible to suppress rotation of the operation lever 41 in such a direction that the fixing of the connector is canceled. As a result, the connector 10 can be stably fixed to the casing 100.

4 The fixing members 12 are each configured as an integral member by attaching the fixing shaft 31 to the operation lever 41. The through hole 26 of each flange 24 has a non-circular cross-sectional shape. Rotation of the fixing shaft 31 from a position at which the protrusion 34 cannot pass through the through hole 26 to the position at which the protrusion 34 can pass through the through hole 26 is restricted due to the operation lever 41 coming into contact with the main body 21. With this configuration, it is possible to prevent a situation in which the fixing shaft 31 comes out of the through hole 26 of the flange 24 and the fixing member 12 comes off the housing 11.

5 The operation lever 41 includes an arc-shaped outer circumferential portion that slides relative to the flange 24 when the operation lever 41 is rotated between the rotational position of the operation lever 41 at which the fixing shaft 31 is located at the locked position A1 and the rotational position of the operation lever 41 at which the fixing shaft 31 is located at the unlocked position A2. The outer circumferential portion is the outer circumferential portion of the rotary portion 42. According to this configuration, the operation lever 41 can be rotated more smoothly relative to the flange 24, and therefore, operability of the operation lever 41 is improved.

### Other Embodiments

The above embodiment can be implemented with the following modifications. The above embodiment and the following modification examples can be implemented in combination with each other as long as there is no technical contradiction.

The material of the housing 11 is not particularly limited. The housing 11 is made of resin, for example. In this case, for example, the resins exemplified for the fixing members 12 can be used to form the housing 11.

The cross-sectional shape of the through holes 26 of the flanges 24 and the cross-sectional shapes of the shaft portions 32 and the protrusions 34 of the fixing shafts 31 are not limited to a combination of a circle and a quadrilateral, such as a keyhole shape, as long as the protrusions 34 can pass through the through holes 26 only when the protrusions 34 are at a predetermined rotational position around the shaft portions 32. These cross-sectional shapes may also be a polygonal shape, for example.

The cam mechanism of the operation lever is not limited to the eccentric cam, and may be any mechanism that converts the movement of the operation lever 41 in the operating direction into the movement of the fixing shaft 31 in the axial direction. For example, it is also possible to adopt an operation lever 41 whose operating direction is a first direction other than the axial direction of the fixing shaft 31, and the cam mechanism may convert linear movement of the operation lever 41 in the first direction into the movement of the fixing shaft 31 in the axial direction.

The cam mechanism may be configured such that the top position A3 is not on the way of the fixing shaft 31 moving from the locked position A1 to the unlocked position A2 in conjunction with the movement of the operation lever 41 in the operating direction. For example, the cam mechanism may be configured such that the top position A3 is the locked position A1, or a position closer to the unlocked position A2 than the top position A3 is the locked position A1.

The shape of the outer circumferential portion of the rotary portion 42 is not limited to an arc shape. For example, the outer circumferential portion of the rotary portion 42 may have a polygonal shape or a shape obtained by combining an arcuate curve and a straight line.

It is also possible to provide a resistance applying portion that applies resistance to the movement of the operation lever 41 in the direction from the position of the operation lever 41 when the fixing shaft 31 is located at the locked position A1 to the position of the operation lever 41 when the fixing shaft 31 is located at the unlocked position A2. In this case, when the fixing shaft 31 is located at the locked position A1, even if a force is applied by unintentional contact or the like to the operation lever 41 in a direction to rotate the operation lever 41, it is possible to suppress rotation of the operation lever 41 in the direction in which the fixing of the connector is canceled. As a result, the connector 10 can be stably fixed to the casing 100.

As the resistance applying portion, for example, a portion that is partially straight may be provided in the arc-shaped outer circumferential portion of the rotary portion 42. Alternatively, it is also possible to provide, as the resistance applying portion, a projection that comes into contact with the operation lever 41 to apply resistance at a predetermined timing while the operation lever 41 is being rotated.

Although the two flanges 24 are provided in the embodiment, the number of flanges 24 may be one, or three or more. Although the two fixing members 12 are provided in the embodiment, the number of fixing members 12 may be one, or three or more. In addition, the fixing members 12 do not have to be attached to all the flanges 24, and the connector may include a flange 24 to which a fixing member 12 is attached and a flange 24 to which no fixing member 12 is attached.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising:
a housing; and
a fixing member made of resin and configured to fix the housing to a plate-shaped casing,
wherein the housing includes a main body and a flange protruding outward from the main body,
the fixing member includes a fixing shaft, an operation lever for operating the fixing shaft, and a cam mechanism configured to move the fixing shaft in conjunction with operation of the operation lever,
the fixing shaft includes a shaft portion that is inserted through a through hole provided in the flange and a protrusion protruding from an outer circumferential surface of the shaft portion and configured to sandwich the casing between the protrusion and the flange,
the cam mechanism converts movement of the operation lever in an operating direction into movement of the fixing shaft in an axial direction, and
in conjunction with the movement of the operation lever in the operating direction, the fixing shaft moves between a locked position at which the casing is sandwiched between the flange and the protrusion and an unlocked position at which a distance between the protrusion and the flange is longer than that at the locked position.

2. The connector according to claim 1,
wherein the cam mechanism is an eccentric cam that converts movement of the operation lever in a rotational direction into movement of the fixing shaft in the axial direction,
the fixing shaft is coupled to the operation lever in such a manner as to be rotatable relative to the operation lever, and
a second center that is a rotation center of the fixing shaft in the operation lever is eccentric to a first center that is a rotation center of the operation lever.

3. The connector according to claim 2,
wherein, when a position of the fixing shaft when the second center is farthest from the flange is defined as a top position,
the cam mechanism is configured such that the fixing shaft moves from the locked position to the unlocked position via the top position in conjunction with the movement of the operation lever in the operating direction.

4. The connector according to claim 2, further comprising:
a resistance applying portion that applies resistance to movement of the operation lever in a direction from a rotational position of the operation lever when the fixing shaft is located at the locked position to a rotational position of the operation lever when the fixing shaft is located at the unlocked position.

5. The connector according to claim 1,
wherein the fixing member is an integral member obtained by attaching the fixing shaft to the operation lever,
the through hole of the flange has a non-circular cross-sectional shape, and
rotation of the fixing shaft from a position where the protrusion cannot pass through the through hole to a position where the protrusion can pass through the through hole is restricted due to the operation lever coming into contact with the main body.
